(19) United States
(12) Patent Application Publication
(10) Pub. No.: US 2025/0310994 A1
(43) Pub. Date: Oct. 2, 2025

(54) CONTENTION WINDOW SELECTION

(71) Applicant: Telefonaktiebolaget LM Ericsson (publ), Stockholm (SE)

(72) Inventors: Konstantinos VANDIKAS, Solna (SE); Leif WILHELMSSON, Lund (SE); Athanasios KARAPANTELAKIS, Solna (SE); Karthik R M, Chennai (IN)

(21) Appl. No.: 18/865,143

(22) PCT Filed: Sep. 28, 2022
(86) PCT No.: PCT/EP2022/077044

§ 371 Date: Nov. 12, 2024

(30) Foreign Application Priority Data
May 20, 2022 (GR) 20220100420

(51) Int. Cl. H04W 74/0816; H04L 41/0894; H04L 41/16

(52) U.S. Cl. CPC H04W 74/0816; H04L 41/0894; H04L 41/16

(57) ABSTRACT

A method performed by a controller is provided. The method includes receiving first input information from a first network node. The first input information includes any one or more of: a first group of one or more values for one or more parameters associated with a first contention window, CW, value, a second CW value, and a second group of one or more values for the one or more parameters associated with the second CW value. The method further includes obtaining first policy information indicating a first policy which is determined based at least on the first input information and transmitting towards the first network node the first policy information. The first policy is for determining a third CW value for the first network node.

### TECHNICAL FIELD

Disclosed are embodiments related to method(s), apparatus, and/or system(s) for performing a contention window selection.

### BACKGROUND

There is an increased interest in using license-exempt bands such as the 2.4 GHz industrial, scientific, and medical (ISM) band, the 5 GHz band, the 6 GHz band, and the 60 GHz band, using more advanced channel access technologies. Historically, Wi-Fi has been the dominant standard in license exempt bands when it comes to mobile broadband (MBB) applications. Due to the large available bandwidth and effectively no competing technology in the license exempt band, Wi-Fi, which is based on the IEEE 802.11 standard, has adopted a very simple distributed channel access mechanism based on the so-called distributed coordination function (DCF).

Distributed channel access means that a device (known as a Station (STA) in IEEE 802.11 terminology) tries to access the channel when the device has something to send. Effectively there is no difference in channel access whether the STA is an access point (AP) STA or a non-AP STA. The DCF works well as long as the load is not too high. However, when the load is high, and in particular when the number of STAs trying to access the channel is large, channel access based on the DCF may become unpredictable and result in high latency.

To improve the channel access predictability in Wi-Fi, particularly in networks with a large number of devices, a more centralized channel access is required—i.e., an approach similar to what has been used by cellular networks for the last more than 30 years. Rather than letting any non-AP STA access the channel whenever it has data to send, the channel access may be controlled by the AP. One such controlling mechanism was introduced in IEEE 802.11ax, which, for example, supports orthogonal frequency division multiple access (OFDMA) in both downlink (DL) and uplink (UL). Also, multi-user transmission in form of multi-user multiple input multiple output (MU-MIMO) is supported for both the DL and the UL. By supporting MU transmission, and letting the AP control the channel access, efficient channel usage is achieved, and one can avoid collisions due to contention within a cell. A cell is referred to as basic service set (BSS) in IEEE 802.11 terminology.

Another useful feature in Wi-Fi is the so-called transmission opportunity (TXOP). Since contention for the channel for every single transmission causes a lot of overhead, the notion of a TXOP is introduced. In the TXOP scheme, once a device (e.g., an AP) has gained access to the channel, the device may reserve the channel for a specific time during which a number of transmissions in alternating directions can take place without the need of contending for the channel at each time. The use of TXOP does not only improve the spectrum usage, but it allows devices to enter a low power mode, and thus save power. The maximum duration of a TXOP varies for different physical layers (PHY), but is generally in the order of 5 ms.

To further improve the performance, a next natural step is to coordinate the channel usage between cells, i.e., introducing some kind of AP coordination. One relatively straight-forward approach to this is to let a number of APs share a TXOP. Specifically, suppose there are two or more APs within range using the same channel. With no coordination, each of them would contend for the channel and the AP that wins the contention will then reserve the channel using the TXOP concept, whereas the other APs would have to defer from channel access and wait for the TXOP to end. Then a new contention begins and channel access may or may not be gained for a specific AP, implying that channel access becomes rather unpredictable, and thus support for demanding quality of service (QoS) applications may be challenging.

One way to somewhat alleviate the problem described above is using Coordinated OFDMA (COFDMA). In COFDMA, two or more APs contend for the channel, and the winning one obtains a TXOP for, e.g., a 40 MHz channel. However, instead of starting data transmission to the associated STAs, the AP exchanges information with the other APs and shares the available resources. As an example, suppose there are two APs cooperating and both contend for a 40 MHz channel. If AP1 wins the contention, it assigns the lower 20 MHz for itself and the upper 20 MHz for AP2, whereas if AP2 wins the contention, it assigns the upper 20 MHz for itself and assigns the lower 20 MHz for AP1. This illustrates the basic idea of the AP coordination, although in this particular example, it would have been easier to simply split the 40 MHz channel into two 20 MHz channels and just allocate the lower 20 MHz to AP1 and the upper 20 MHz to AP2.

The gain by “joining forces” by means of COFDMA is that it allows for a very dynamic sharing of the available resources from one TXOP to the next and in particular that the channel access can be somewhat more predictable in that an AP will be part of an TXOP even if not all resources can be used for that AP alone.

The improvement on the waiting-time for obtaining channel access is highlighted in “Gain Analysis of Coordinated AP Time/Frequency Sharing in a Transmit Opportunity in 11be,” by Lochan Verma et al., available at https://mentor.ieee.org/802.11/dcn/19/11-19-1879-00-00be-coordinated-ap-time-and-frequency-sharing-gain-analysis.pptx.

### SUMMARY

Certain challenges exist Listen before talk (LBT), as used in Wi-Fi, generally handles collisions in a way that causes large variations in access delay for a device, which means that applications with strict time requirements may not be supported adequately when LBT is used. This problem is alleviated to a significant extent when a more centralized approach in 802.11ax as discussed above is used, and even more when this centralized approach is combined with AP coordination.

Furthermore, in case LBT is used, there is a certain amount of unpredictability due to e.g., a non-negligible risk of collision and other things causing that a packet is not correctly received. As long as the transmitting device does not receive a positive acknowledgement message (an ACK), the transmitting device will update the contention window as if there has been a collision.

The current approach for updating the contention window (CW) is based on so-called exponential back-off. This means that the size of the CW is essentially doubled every time the transmitting device does not receive an ACK. The basic idea with doubling the CW is to reduce the probability of another collision—i.e., the probability that the following transmission will also result in a collision. However, due to the uncontrolled interference situation in unlicensed bands, there are situations where the failed transmission was not due to a collision but was caused by something else. Therefore, there is a need for improving the current approach of updating the CW.

Accordingly, in one aspect of the embodiments of disclosure, there is provided a method performed by a controller. The method comprises receiving from a first network node first input information, wherein the first input information comprises any one or more of: (1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. The method further comprises obtaining first policy information indicating a first policy, wherein the first policy is determined based at least on the first input information; and transmitting towards the first network node the first policy information, wherein the first policy is for determining a third CW value for the first network node.

In other aspect, there is provided a method performed by a first network node. The method comprises transmitting towards a controller first input information, wherein the first input information comprises any one or more of: (1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. The method further comprises receiving first policy information indicating a first policy, wherein the first policy information was transmitted by the controller; and determining a third CW value using the first policy. The first policy is determined based at least on the first input information.

In other aspect, there is provided a method performed by a station, STA. The method comprise receiving a message including a first CW value, wherein the message was broadcasted by a network node. The method further comprises retrieving the first CW value from the message; and using the first CW value to communicate with the network node. The first CW value is determined by a policy, and the policy is determined based on a first group of one or more values for one or more parameters and a second group of one or more values for said one or more parameters, the first group of one or more values is related to communications between the network node and the STA in which a second CW value is used, and the second group of one or more values is related to communications between the network node and the STA in which a third CW value is used.

In other aspect, there is provided a computer program comprising instructions which when executed by processing circuitry cause the processing circuitry to perform the method described above.

In other aspect, there is provided a controller. The controller is configured to receive from a first network node first input information, wherein the first input information comprises any one or more of: (1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. The controller is further configured to obtain first policy information indicating a first policy, wherein the first policy is determined based at least on the first input information; and transmit towards the first network node the first policy information, wherein the first policy is for determining a third CW value for the first network node.

In other aspect, there is provided a first network node. The first network node is configured to transmit towards a controller first input information, wherein the first input information comprises any one or more of: (1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. The first network node is further configured to receive first policy information indicating a first policy, wherein the first policy information was transmitted by the controller; and determine a third CW value using the first policy, wherein the first policy is determined based at least on the first input information.

In other aspect, there is provided a station, STA. The STA is configured to receive a message including a first CW value, wherein the message was broadcasted by a network node; retrieve the first CW value from the message; and use the first CW value to communicate with the network node. The first CW value is determined by a policy, the policy is determined based on a first group of one or more values for one or more parameters and a second group of one or more values for said one or more parameters, the first group of one or more values is related to communications between the network node and the STA in which a second CW value is used, and the second group of one or more values is related to communications between the network node and the STA in which a third CW value is used.

In other aspect, there is provided an apparatus. The apparatus comprises a processing circuitry; and a memory, said memory containing instructions executable by said processing circuitry, whereby the apparatus is operative to perform the method of described above.

Embodiments of this disclosure allow determining a more predictable size of CW, which results in increased throughput and deduced delay jitter. This, in turn, allows for supporting particular applications that have more demanding QoS requirements in a better way.

The accompanying drawings, which are incorporated herein and form part of the specification, illustrate various embodiments.

### BRIEF DESCRIPTION OF THE DRAWINGS

FIG. 1 shows a system according to some embodiments.

FIG. 2 shows an exemplary scenario where the system is used.

FIG. 3 illustrates the concept of contention window.

FIG. 4 shows a process according to some embodiments.

FIG. 5 shows a process according to some embodiments.

FIG. 6 shows a process according to some embodiments.

FIG. 7 shows an apparatus according to some embodiments.

FIG. 8 shows an apparatus according to some embodiments.

FIG. 9 shows a process according to some embodiments.

### DETAILED DESCRIPTION

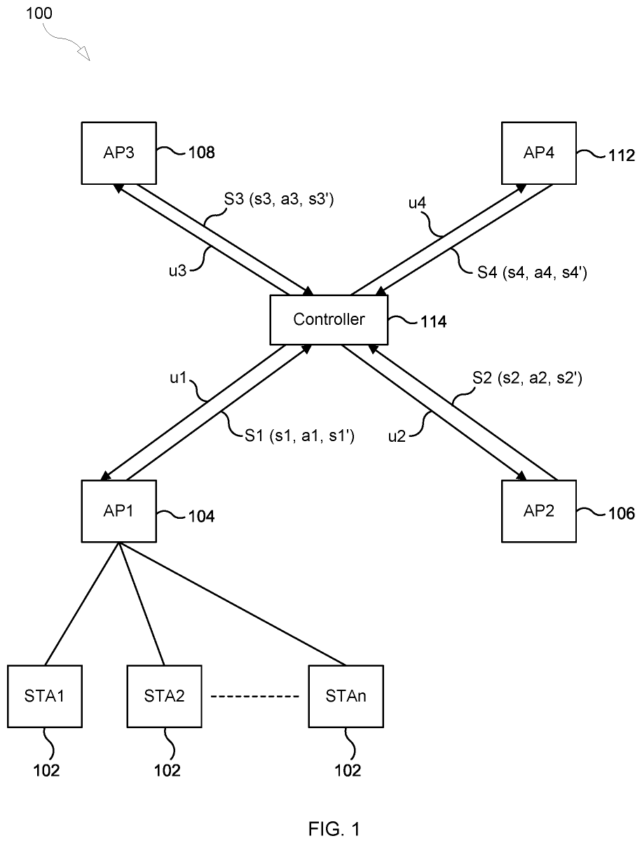

FIG. 1 shows a network system 100 according to some embodiments. As shown in FIG. 1, the network system 100 comprises a plurality of STAs 102, a first AP 104, a second AP 106, a third AP 108, a fourth AP 112, and an AP controller 114. Each of the first, second, third, and fourth APs 104-112 may be configured to provide wireless connection(s) for one or more STAs 102, and the AP controller 114 is configured to control operations of the APs 104-112. The number of the entities (e.g., STAs, APs, etc.) shown in FIG. 1 is provided for illustration purpose only and does not limit the embodiments of this disclosure in any way. For example, in some embodiments, more than four APs may be connected to the AP controller 114 while, in other embodiments, less than four APs may be connected to the AP controller 114.

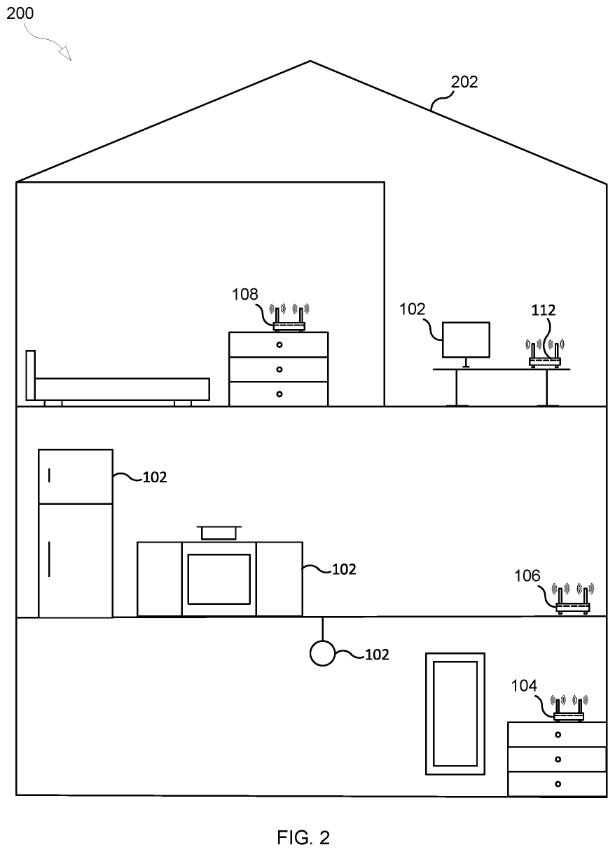

FIG. 2 shows an exemplary scenario 200 where the network system 100 is implemented. In the exemplary scenario 200, the wireless system 100 is configured to provide a mesh Wi-Fi network. Here, each of the APs 104-112 is a mesh Wi-Fi router configured to provide wireless connections for STAs 102 (e.g., the computer, the smart refrigerator, the smart oven, and the smart light shown in FIG. 2) within a particular area of a house 202 (e.g., the basement, the kitchen, the bedroom, the office, etc.). Via the APs 104-112, the STAs 102 can transmit and/or receive data (e.g., streaming YouTube™ videos).

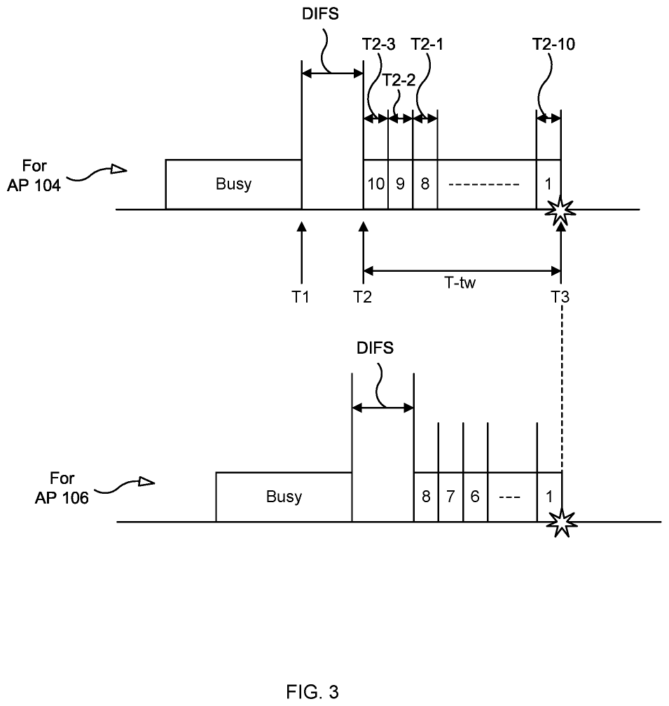

In some scenarios, the APs 104-112 may share the same physical channels. In such scenarios, in case two or more of the APs 104-112 transmit data at the same time, collision of data occurs. Random access (RA) may be used to prevent such collision. RA is commonly used when uncoordinated devices (e.g., the APs 104-112) are to access the same channel. FIG. 3 illustrates an example of RA.

As shown in FIG. 3, in case it is determined that collision of data transmission occurs (e.g., at T1), when RA is adopted, a device (e.g., the AP 104) may generate a random number (e.g., 10) within a time interval (e.g., distributed inter-frame space (DIFS)) from the timing of determining the collision and decrease this number by one (i.e., counting down the number) at predetermined time intervals (e.g., T2-1, T2-2, T2-3, . . . , T2-10). The time interval between the start of the counting and the end of the counting is referred as contention window (CW) and each of the predetermined time intervals (e.g., T2-1, T2-2, T2-3, . . . , T2-10) is referred as a slot.

As shown in FIG. 3, the random number (e.g., 10) generated by the device determines how many slots the device should wait until the device can transmit data again. The number that is being counted down (e.g., 10, 9, 8, . . . , 1) is referred as the back-off (BO). The number corresponds to the number of slots that the device (e.g., the AP 104) must back-off from transmitting. For example, at T2, the BO is 10 (i.e., the device should wait 10 time slots until the device can transmit data). The device may include a counter that keeps track of the BO number. The counter is referred as the BO counter.

If the RA is performed on a dedicated channel only used for RA, the device (e.g., the AP 104) may simply start a transmission as soon as the BO counter reaches zero (e.g., at timing T3). However, then there is a risk that another device (e.g., the AP 106) also has a BO counter reaching zero at the same time. This leads to data transmission collision, which typically results in that neither of the transmissions by the two devices will be successful. This probability, however, can be made small enough by selecting the CW which is sufficiently large. More specifically, selecting a large CW implies that it would take longer for the BO counter to reach zero, thereby reducing the probability of collision. But reducing the probability of collision by selecting a large CW comes at the cost of increased channel access delay.

To somewhat alleviate this trade-off, the concept of exponential BO may be employed. The basic concept of the exponential BO is that a device initially uses a relatively small CW to obtain a small delay. However, in case there is collision (e.g., there is a lost packet), the size of CW is increased for retransmission so that the probability of collision for the retransmission is reduced. For example, the size of the CW can be doubled up until a maximum CW size is reached. Because the size of the CW increases exponentially, this scheme is referred to as exponential BO.

In some systems, however, there is no dedicated channel for RA but instead the RA is performed on the same channel which is used for transmission of data. This is for instance the case for many standards operating in license exempt bands (a.k.a., “unlicensed bands”). Examples of such standards include IEEE 802.11 and 3GPP Next Generation in Unlicensed bands (NR-U). Dedicated RA channels are commonly used for standards targeting licensed bands.

When the RA is performed on a channel that is also used for transmission of data, initiating a transmission as soon as the BO counter reaches zero will highly likely result in collision with an ongoing data transmission. In order to avoid this collision, the concept of listen before talk (LBT) (a.k.a., carrier sense multiple access with collision avoidance (CSMA/CA)) may be used. With LBT, the channel is sensed and only if the channel is found to be idle, the BO counter is decreased. That is, as long as the channel is found to be busy, the BO counter is frozen.

However, even when LBT is used in order to determine when to start a transmission, there is still a small risk of collision because two devices performing RA with LBT may initiate the transmission at the same time.

Accordingly, embodiments of this disclosure provide improved method(s), apparatus, or system(s) for selecting a CW for a device at a given moment of time.

In some embodiments of this disclosure, data transmissions of two or more APs are coordinated. The coordinated data transmission of multiple APs would result in more predictable channel access, significant reduction of delay on data transmission, increased throughputs.

Referring back to FIG. 1, the network system 100 provides a Multi-AP setup with 4 APs which are sharing different physical channels. Between each of the APs 104-112 and the AP controller 114, there is a wired or a wireless channel for communication.

Even though, in FIG. 1, the AP controller 114 is a separate entity that is different from any of the APs 104-112, in some embodiments, the AP controller 114 can be implemented as a logical function and hosted in one of the APs 104-112. Furthermore, in other embodiments, the logical function of the AP controller 114 may migrate between the APs 104-112 depending on the available computational capacity of each of the APs 104-112.

In order to provide coordinated data transmission of multiple APs, in some embodiments, the CWs for the APs 104-112 may be selected jointly between the APs 104-112. More specifically, according to some embodiments, the CWs for the APs 104-112 may be selected by using a deep reinforcement learning (RL) algorithm of the actor-critic category, wherein the RL algorithm is trained using a collection of state data from the APs 104-112.

In RL, an agent takes an action against an environment given a state, and receives a reward and a new state. The goal for the agent is to learn the optimal policy, i.e., learn to take the action that yields the maximum current and future-discounted reward in every state of the environment. RL algorithms are very well suited for dynamic environments such as those of Wi-Fi access.

In Wi-Fi, considering the unlicensed nature of the spectrum, the stochasticity of the background “noise” in the wireless channel(s) in which access point(s) are active renders a supervised learning approach (where a preexisting dataset is used to train a machine learning model) inefficient. For example, in many cases, preexisting dataset used for training a machine learning (ML) model does not capture the variance of conditions that exist in the real world. On the contrary, in reinforcement learning (RL), the training of a model is tailored to channel conditions of the AP neighborhood, without requiring any prior data, through exploration and exploitation of the agent.

Thus, in some embodiments of this disclosure, a Markov Decision Process (e.g., used in RL) may be used for determining CWs for the APs 104-112. More specifically, in one example, each of the APs 104-112 may train its own deep neural network (“actor”), which may learn to take a globally optimal action. The optimality of the action taken by the deep neural network (“NN”) of each of the APs 104-112 may be measured by another deep NN (“critic”) that is common for all the agents. The critic may reside within the AP controller 114, and may use state-action pairs from all the actors to estimate Q-values for an action of an actor (Q-value is a measure of action optimality).

As discussed above, a multi-agent RL approach may be used to determine CWs for the APs 104-112. In the multi-agent RL approach, the critic NN model residing in the AP controller 114 may receive from the RL agents (e.g., the processes performed by the APs 104-112) different parameters (a.k.a., “input information”) related to state space where the RL agents reside, and may be trained based on aggregations of the received parameters. The trained critic NN model can be shared across all RL agents. Examples of such parameters are shown in Table 1 below.

TABLE 1

| Parameter | |
|---|---|
| Name | Description |
| STA_{—} | A distribution of access delay per STA, where access delay |
| access_{—} | is the time (in ms) from the moment that an STA tried to |
| delay | access a channel to the moment it got access. This |
| | information can be delivered as a metric between the STAs |
| | and the APs. The APs then transmit this information to the |
| | controller and the controller produces the distribution per |
| | AP. This is measured for a given time period. |
| Global_{—} | A distribution of throughput (bits per sec) per AP for a given |
| throughput | time period. This can be seen as a measure of utilization of |
| (avg/min/ | each AP. From this information, additional measures such |
| max/sum) | as global throughput - avg, min, max, sum may be produced. |
| Packet_{—} | The distribution of the packet drop rate per AP for a given |
| drop_rate | time period |
| Jitter | Distribution of jitter per AP where jitter is the time delay for |
| | packet transmission between STA and AP. |
| STAs_{—} | Distribution of STAs per AP - this can be useful in terms of |
| per_AP | measuring the density per AP. It is noted that CW may be |
| | affected by this distribution. |

In this disclosure, an action space is defined as CW size, which can be defined as a number that is between CWmin and CWMax as shown in Table 2 below. Table 2 shows CWmin and CWmax for different Wi-Fi standards.

TABLE 2

| PHY | CWmin | CWmax |
|---|---|---|
| 802.11b | 31 | 1023 |
| 802.11g | 15 or 31 | 1023 |
| 802.11a | 15 | 1023 |
| 802.11n | 15 | 1023 |
| 802.11ac | 15 | 1023 |

In some embodiments of this disclosure, a reward function r (where r∈[0 . . . 1]) may be defined as:

$$R ( s , a , {s}^{′} ) = \{ \begin{matrix}2 - ( norm ( {s}^{′} [ j ] ) - norm ( s [ j ] ) ) - ( norm ( {s}^{′} [ pdr ] ) - norm ( s [ pdr ) ) ] \\ if norm ( {s}^{′} [ gt ] \geq norm ( s [ gt ] ) \\ 0 otherwise\end{matrix}$$

where norm is a function that implements min max scaling, thus limiting every value to a range between [0,1]. This reward function is for capturing the difference in the state before and after the action (CW size) as stated by the agent.

If there is an increase in throughput, the increase may be discounted by any jitter or packet drops that might have occurred. Conversely, if there is no increase in the throughput, the lowest possible reward may be directly provided to the agent.

Additionally or alternatively, there may be provided a different reward function that rewards the agent when delay (i.e., the overall time each STA waits to access the channel) is decreasing:

$$R ( s , a , {s}^{′} ) = \{ \begin{matrix}2 - ( norm ( {s}^{′} [ j ] ) - norm ( s [ j ] ) ) - ( norm ( {s}^{′} [ pdr ] ) - norm ( s [ pdr ) ) ] \\ if norm ( {s}^{′} [ gd ] \leq norm ( s [ gd ] ) \\ 0 otherwise\end{matrix}$$

As shown above, according to the embodiments of this disclosure, the reward function now depends on new global delay (gd) which is collected in s′ as well as old global delay which is collected in s. If the difference between the new global delay and the old global delay is lower or equal to zero (delay decreases), then the reward of the agent may be set to be the lowest score (e.g., 0). On the other hand, if the difference between the new global delay and the old global delay is greater than 0, then the reward of the agent may be discounted by any packet drops and jitter.

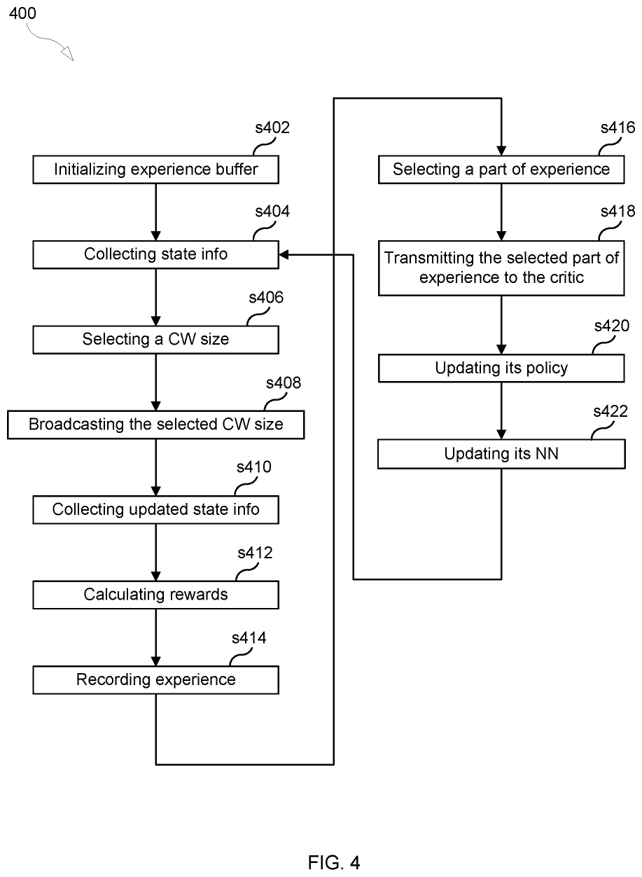

FIG. 4 shows a process 400 performed by each of the APs 104-112 according to some embodiments. In some embodiments, the APs 104-112 perform the process 400 simultaneously. However, in other embodiments, the APs 104-112 perform the processes 400 sequentially. It is noted that the order of the APs 104-112 performing the process 400 is not limited to a particular way.

The process 400 may begin with step s402. Step s402 comprises an agent in each of the APs 104-112 initializing its corresponding experience buffer. In this disclosure, an agent in each of the APs 104-112 may correspond to a hardware entity (e.g., a processor) or a software entity (e.g., program code for performing one or more processes). The experience buffer included in each of the APs 104-112 is configured to store “experience data” which will be used for learning its corresponding action value function (a.k.a., “Q function”) Q(s,a). Detailed information about the “experience data” is provided below.

The action value function (i.e., the Q function) is configured to generate an expected future reward for performing a given action in a given state. Since, in this disclosure, an action corresponds to a CW size, the action value function is configured to generate an expected future reward for using a given CW size in a given state.

Referring back to FIG. 4, step s404 comprises the agent of each of the APs 104-112 observing its own state and collecting state information (“s”). Here, the state information (“s”) is information related to an operation state of an AP or a state of a network associated with an AP. Examples of the state information are the parameters shown in Table 1 above—e.g., a global throughput, a packet drop rate, a jitter, an access delay per STA, etc. The state information for each of the APs 104-112 may be stored in a storage medium of each of the APs 104-112. In some embodiments, the state information may be stored in a storage as a vector in N-dimension, wherein N corresponds to the number of parameters of which values are collected (e.g., 5 in Table 1).

Step s406 comprises the agent of each of the APs 104-112 selecting an action (i.e., selecting a CW size for the AP) using the state information s collected in step s404 and its individualized policy μ. The individualized policy μ may be produced by a critic included in the AP controller 114. Like the agents, the critic may be a hardware entity (e.g., the processor included in the AP controller 14) or a software entity (e.g., program code for performing one or more processes). The action may be defined as: argmaxQ_{θ}^{μ}(s, a), where θ is a set of parameters for a neural network (“NN”) of each agent. The NN of each of the agents is configured to select an action that maximizes the Q-value (i.e., the reward) based on the state information of each agent and the policy of each agent. Thus, the selected action for agent #1 of the AP 104 may be defined as a1=argmaxQ_{θ1}^{μ1}(s1, a1) and the selected action for agent #2 of the AP 106 may be defined as a2=argmaxQ_{θ2}^{μ2}(s2, a2).

In case step s406 corresponds to a part of a training process, a1—i.e., the action chosen by agent #1 (i.e., the initial CW value selected by agent #1)—may be set to be a random value with probability 1−ε (ε-greedy policy).

Step s408 comprises each of the APs 104-112 broadcasting to its associated STAs the selected action—i.e., the selected CW size.

Step s410 comprises the agent of each of the APs 104-112 observing changes that have occurred in its state as a consequence of using the CW size selected in step s406. The step of observing the state changes (i.e., collecting updated state information) may occur immediately after beginning to use the selected CW size. The updated state information (s′) may be collected once or many times. Here, the updated state information (s′) is information related to an operation state of an AP or a state of a network associated with an AP after using an updated CW size.

Step s412 comprises the agent of each of the APs 104-112 calculating its reward based on the previous state (corresponding to the state information collected in step s404), the CW size selected in step s406, and the current state (corresponding to the state information collected in step s410). An exemplary way of calculating the reward is described above. As known in the art, the reward in the context of ML is a value indicating how desirable an agent's action was in a given state. Thus, here the reward indicates how desirable a selected CW was given the operation state of an AP and/or a condition of a network associated with the AP.

Step s414 comprises the agent of each of the APs 104-112 recording its experience in its corresponding experience buffer. The experience data may be a tuple consisting of the original state s (measured in step s404), next state s′ (measured in step s410), reward r (calculated in step s412) and action a (determined in step s406).

Step s416 comprises the agent of each of the APs 104-112 selecting a part of experience data (e.g., the original state, the next state, and the action—i.e., the experience data excluding the reward). In some embodiments, an embedding (i.e., a linear transformation of the sample space) or a dimension reduction technique to decrease the size of the experience data while maintaining a representative distribution which can be used by the critic to train its NN mode.

Step s418 comprises the agent of each of the APs 104-112 transmitting the selected part of the experience data (a.k.a., “input information”) to the critic. For example, the agent of the AP 104 may transmit first input information (e.g., S1) to the controller 114 and the agent of the AP 106 may transmit second input information (e.g., S2) to the controller 114. As discussed above, the first input information (S1) may be a tuple consisting of the original state s, the next state s, and the reward r.

The part of the experience data transmitted by each of the APs 104-112 may be used by the critic in order to determine a policy for the agent of each of the APs 104-112. More specifically, the critic may use the input information received from each of the APs 104-112 to determine a policy for each agent After calculating the policy for the agent of each of the APs 104-112, the critic may transmit policy information indicating the calculated policy to each of the APs 104-112. Here, the policy information is information about a policy. As known in the field of ML, a policy is a function for selecting an action based on one or more inputs (e.g. a given state). A very simplified conceptual example of the policy is shown in the table below.

| State | Action | Inclination to take the Action |
|---|---|---|
| S1 | A1 | 0.75 |
| S1 | A2 | 0.2 |
| S2 | A1 | 0.1 |
| S2 | A2 | 0.92 |

As shown above, given that the current state is S1, the policy may indicate that it's desirable to take action A1 than action A2 (based on the inclination values given to the actions for a given state).

Step s420 comprises the agent of each of the APs 104-112 updating its policy based on the calculated policy transmitted by the critic.

In some embodiments, steps s414-s420 may be repeated. More specifically, the agent of each of the APs 104-112 may continuously record experience, transmit updated experience data, and receive from the critic a policy that has been updated based on the updated experience data. By repeating these steps, the policy of the agent of each of the APs 104-112 may be continuously updated.

Step s426 comprises the agent of each of the APs 104-112 updating its NN based on the updated policy.

After performing step s426, the process 400 may return to step s404 and the steps following step s404 may be performed.

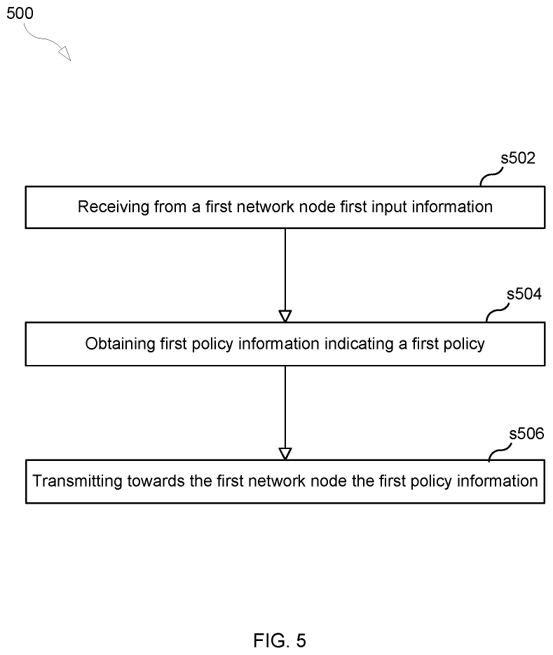

FIG. 5 shows a process 500 performed by a controller. Process 500 may begin with step s502. Step s502 comprises receiving from a first network node first input information, wherein the first input information comprises any one or more of: 1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. Step s504 comprises obtaining first policy information indicating a first policy, wherein the first policy is determined based at least on the first input information. Step s506 comprises transmitting towards the first network node the first policy information, wherein the first policy is for determining a third CW value for the first network node.

In some embodiments, the method comprises receiving from a second network node second input information, wherein the second input information comprises any one or more of: (1) a third group of one or more values for said one or more parameters, wherein the third group of values is related to communications of the second network node in which a fourth contention window, CW, value is used; (2) a fifth CW value for the second network node; and (3) a fourth group of one or more values for said one or more parameters, wherein the fourth group of values is related to communications of the second network node in which the fifth CW value is used. The method further comprises obtaining second policy information indicating a second policy, wherein the second policy is determined based at least on the first input information and the second input information; and transmitting towards the second network node the second policy information, wherein the second policy is for determining a sixth CW value for the second network node.

In some embodiments, the first policy is determined based additionally on the second input information.

In some embodiments, said one or more parameters are selected from a group of information comprising: an access delay, a throughput, a packet drop rate, a packet transmission delay, or a distribution of stations, STAs.

In some embodiments, obtaining the first policy information comprises determining the first policy and generating the first policy information which indicates the determined first policy.

In some embodiments, the first network node is an access point.

In some embodiments, the controller is included in an access point, and a set of one or more stations, STAs, is connected to the access point.

In some embodiments, the method further comprises determining the third CW value using the first policy.

In some embodiments, the third CW value is determined by using a machine learning, ML, model based on the first policy information and the second group of one or more values for said one or more parameters.

In some embodiments, the third CW value is determined based on argmaxQ_{θ}^{μ}(s, a), where θ is a set of parameters of the ML model, μ is the first policy information, s is the second group of one or more values for said one or more parameters, Q is a Q-function, and a is the third CW value.

In some embodiments, the method further comprises broadcasting the third CW value, wherein the broadcasted third CW value is received by the set of STAs.

In some embodiments, the method further comprises communicating with the set of STAs using the third CW value; and based on characteristics of the communications between the first network node and the set of STAs, determining a third group of one or more values for said one or more parameters.

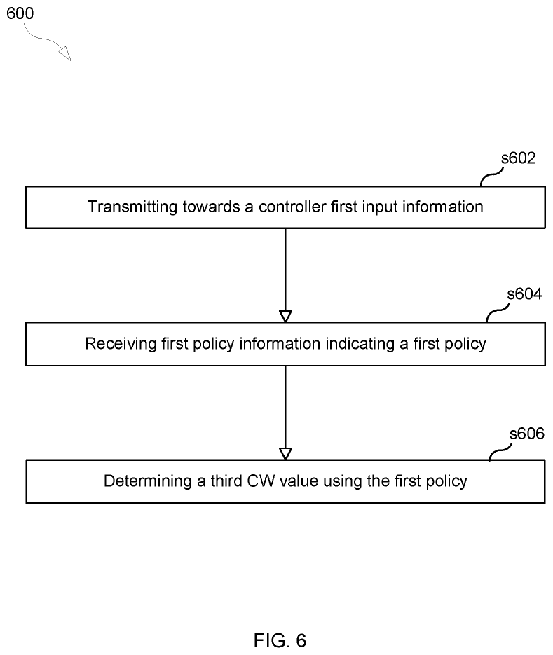

FIG. 6 shows a process 600 performed by a first network node. Process 600 may begin with step s602. Step s602 comprises transmitting towards a controller first input information, wherein the first input information comprises any one or more of: (1) a first group of one or more values for one or more parameters, wherein the first group of values is related to communications of the first network node in which a first contention window, CW, value is used; (2) a second CW value for the first network node; and (3) a second group of one or more values for said one or more parameters, wherein the second group of values is related to communications of the first network node in which the second CW value is used. Step s604 comprises receiving first policy information indicating a first policy, wherein the first policy information was transmitted by the controller. Step s606 comprises determining a third CW value using the first policy, wherein the first policy is determined based at least on the first input information.

In some embodiments, said one or more parameters are selected from a group of information comprising: an access delay, a throughput, a packet drop rate, a packet transmission delay, or a distribution of stations, STAs.

In some embodiments, the first network node is an access point, and a set of one or more stations, STAs, is connected to the access point.

In some embodiments, the method further comprises transmitting the third CW value, wherein the transmitted third CW value is received by the set of STAs.

In some embodiments, the method further comprises communicating with the set of STAs using the third CW value; based on characteristics of the communications between the first network node and the set of STAs, determining a third group of one or more values for said one or more parameters; and transmitting towards the controller second input information comprising the third group of one or more values.

In some embodiments, the third CW value is determined by using a machine learning, ML, model based on the first policy information and the second group of one or more values for said one or more parameters.

In some embodiments, the third CW value is determined based on argmaxQ_{θ}^{μ}(s, a), where θ is a set of parameters of the ML model, μ is the first policy information, s is the second group of one or more values for said one or more parameters, Q is a Q-function, and a is the third CW value.

In some embodiments, the controller is included in an access point.

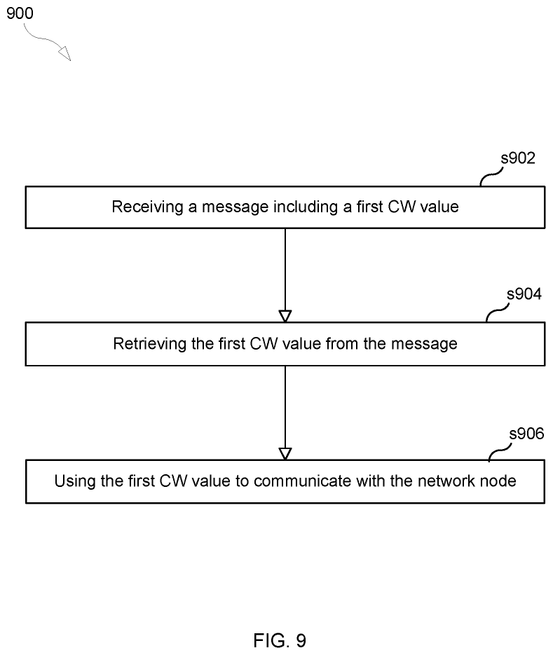

FIG. 9 shows a process 900 performed by a station, STA, according to some embodiments. Process 900 may begin with step s902. Step s902 comprises receiving a message including a first CW value, wherein the message was broadcasted by a network node. Step s904 comprises retrieving the first CW value from the message. Step s906 comprises using the first CW value to communicate with the network node. The first CW value is determined by a policy, and the policy is determined based on a first group of one or more values for one or more parameters and a second group of one or more values for said one or more parameters. The first group of one or more values is related to communications between the network node and the STA in which a second CW value is used, and the second group of one or more values is related to communications between the network node and the STA in which a third CW value is used.

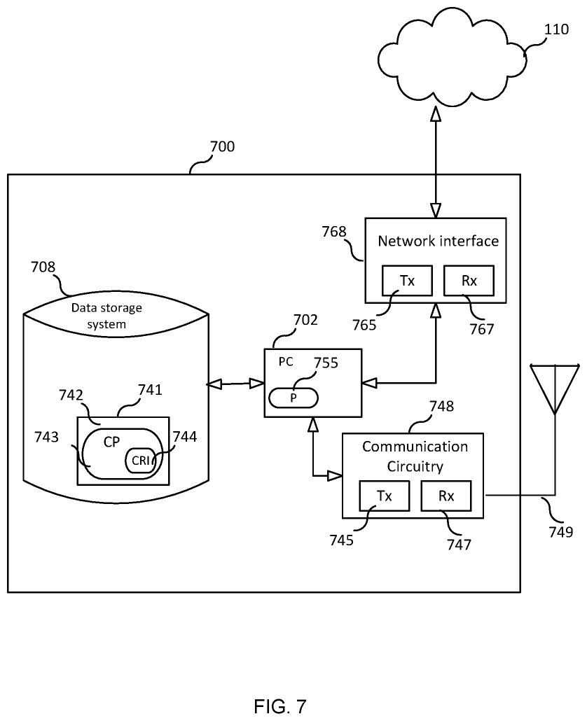

FIG. 7 is a block diagram of each of the APs 104-112 and/or STA 102, according to some embodiments. As shown in FIG. 7, the AP may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); a network interface 768 comprising a transmitter (Tx) 765 and a receiver (Rx) 767 for enabling apparatus 700 to transmit data to and receive data from other nodes connected to a network 110 (e.g., an Internet Protocol (IP) network) to which network interface 748 is connected; communication circuitry 748, which is coupled to an antenna arrangement 749 comprising one or more antennas and which comprises a transmitter (Tx) 745 and a receiver (Rx) 747 for enabling the AP to transmit data and receive data (e.g., wirelessly transmit/receive data); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the AP to perform steps described herein (e.g., steps described herein with reference to the flow charts). In other embodiments, the AP may be configured to perform steps described herein without the need for code. That is, for example, PC 702 may consist merely of one or more ASICs. Hence, the features of the embodiments described herein may be implemented in hardware and/or software.

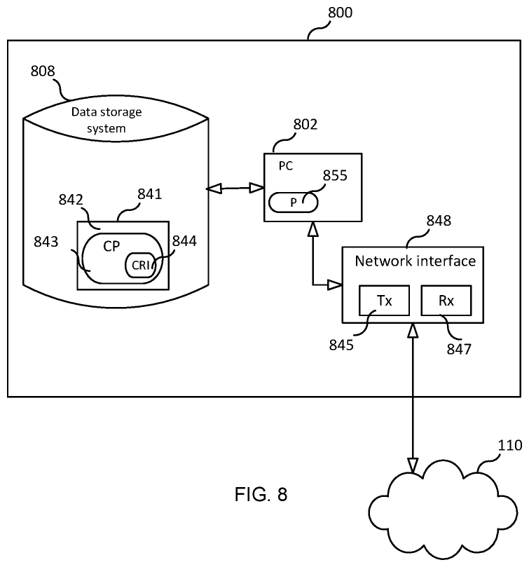

FIG. 8 is a block diagram of an apparatus 800, according to some embodiments, for implementing the controller 114 and/or STA 102. As shown in FIG. 8, apparatus 800 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 800 may be a distributed computing apparatus); a network interface 848 comprising a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes apparatus 800 to perform steps described herein (e.g., steps described herein with reference to the flow charts). In other embodiments, apparatus 800 may be configured to perform steps described herein without the need for code. That is, for example, PC 802 may consist merely of one or more ASICs. Hence, the features of the embodiments described herein may be implemented in hardware and/or software.

1. A method performed by a controller, the method comprising:
receiving from a first network node first input information, wherein the first input information comprises any one or more of:
a first group of one or more values for one or more parameters, the first group of values being related to communications of the first network node in which a first contention window, CW, value is used;
a second CW value for the first network node; and
a second group of one or more values for the one or more parameters, wherein the second group of values is related to communications of the first network node in which the second CW value is used;
obtaining first policy information indicating a first policy, the first policy being determined based at least on the first input information; and
transmitting the first policy information towards the first network node, the first policy being for determining a third CW value for the first network node.

2. The method of claim 1, further comprising:
receiving from a second network node second input information, wherein the second input information comprises any one or more of:
a third group of one or more values for the one or more parameters, wherein the third group of values is related to communications of the second network node in which a fourth contention window, CW, value is used;
a fifth CW value for the second network node; and
a fourth group of one or more values for the one or more parameters, wherein the fourth group of values is related to communications of the second network node in which the fifth CW value is used;
obtaining second policy information indicating a second policy, wherein the second policy is determined based at least on the first input information and the second input information; and
transmitting towards the second network node the second policy information, wherein the second policy is for determining a sixth CW value for the second network node.

3. The method of claim 2, wherein the first policy is determined based additionally on the second input information.

4. The method of claim 1, wherein the one or more parameters are selected from a group of information comprising: an access delay, a throughput, a packet drop rate, a packet transmission delay, or a distribution of stations, STAs.

5. The method of claim 1, wherein obtaining the first policy information comprises determining the first policy and generating the first policy information which indicates the determined first policy.

6. The method of claim 1, wherein the first network node is an access point.

7. The method of claim 1, wherein
the controller is included in an access point, and
a set of one or more stations, STAs, is connected to the access point.

8. The method of claim 7, further comprising determining the third CW value using the first policy.

9. (canceled)

10. (canceled)

11. The method of claim 7, further comprising broadcasting the third CW value, wherein the broadcasted third CW value is received by the set of STAs.

12. The method of claim 7, further comprising:
communicating with the set of STAs using the third CW value; and
based on characteristics of the communications between the first network node and the set of STAs, determining a third group of one or more values for the one or more parameters.

13. A method performed by a first network node, the method comprising:
transmitting towards a controller first input information, wherein the first input information comprises any one or more of:
a first group of one or more values for one or more parameters, wherein the first group of values is related to communications of the first network node in which a first contention window, CW, value is used;
a second CW value for the first network node; and
a second group of one or more values for the one or more parameters, the second group of values being related to communications of the first network node in which the second CW value is used;
receiving first policy information indicating a first policy, the first policy information having been transmitted by the controller; and
determining a third CW value using the first policy, the first policy being determined based at least on the first input information.

14. The method of claim 13, wherein the one or more parameters are selected from a group of information comprising: an access delay, a throughput, a packet drop rate, a packet transmission delay, or a distribution of stations, STAs.

15. The method of claim 13, wherein the first network node is an access point, and a set of one or more stations, STAs, is connected to the access point.

16. The method of claim 15, further comprising transmitting the third CW value, wherein the transmitted third CW value is received by the set of STAs.

17. The method of claim 16, further comprising:
communicating with the set of STAs using the third CW value;
based on characteristics of the communications between the first network node and the set of STAs, determining a third group of one or more values for the one or more parameters; and
transmitting towards the controller second input information comprising the third group of one or more values.

18. (canceled)

19. (canceled)

20. The method of claim 13, wherein the controller is included in an access point.

21.-23. (canceled)

24. A controller configured to:
receive from a first network node first input information, wherein the first input information comprises any one or more of:
a first group of one or more values for one or more parameters, wherein the first group of values is related to communications of the first network node in which a first contention window, CW, value is used;
a second CW value for the first network node; and
a second group of one or more values for the one or more parameters, the second group of values being related to communications of the first network node in which the second CW value is used;
obtain first policy information indicating a first policy, the first policy being determined based at least on the first input information; and
transmit towards the first network node the first policy information, the first policy being for determining a third CW value for the first network node.

25. The controller of claim 24, wherein the controller is further configured to:
receive from a second network node second input information, wherein the second input information comprises any one or more of:
a third group of one or more values for the one or more parameters, wherein the third group of values is related to communications of the second network node in which a fourth contention window, CW, value is used;
a fifth CW value for the second network node; and
a fourth group of one or more values for the one or more parameters, wherein the fourth group of values is related to communications of the second network node in which the fifth CW value is used;
obtain second policy information indicating a second policy, wherein the second policy is determined based at least on the first input information and the second input information; and
transmit towards the second network node the second policy information, wherein the second policy is for determining a sixth CW value for the second network node.

26. A first network node, the first network node being configured to:
transmit first input information towards a controller, the first input information comprising any one or more of:
a first group of one or more values for one or more parameters, wherein the first group of values is related to communications of the first network node in which a first contention window, CW, value is used;
a second CW value for the first network node; and
a second group of one or more values for the one or more parameters, the second group of values being related to communications of the first network node in which the second CW value is used;
receive first policy information indicating a first policy, the first policy information having been transmitted by the controller; and
determine a third CW value using the first policy, the first policy being determined based at least on the first input information.

27. The first network node of claim 26, wherein the first network node is further configured to select the one or more parameters from a group of information comprising: an access delay, a throughput, a packet drop rate, a packet transmission delay, or a distribution of stations, STAs.

28. (canceled)

29. (canceled)
